(19) United States
(12) Patent Application Publication
(10) Pub. No.: US 2022/0382821 A1
(43) Pub. Date: Dec. 1, 2022

(54) METHOD FOR RECOMMENDING SOCIAL USER, ELECTRONIC DEVICE AND NON-TRANSITORY COMPUTER-READABLE STORAGE MEDIUM

(71) Applicant: BEIJING DAJIA INTERNET INFORMATION TECHNOLOGY CO., LTD., Beijing (CN)

(72) Inventor: Chuang LIAO, Beijing (CN)

(21) Appl. No.: 17/817,693

(22) Filed: Aug. 5, 2022

Related U.S. Application Data
(63) Continuation of application No. PCT/CN2021/075580, filed on Feb. 5, 2021.

(30) Foreign Application Priority Data
Feb. 5, 2020 (CN) 202010080668.7

(51) Int. Cl. G06F 16/9536; G06F 16/9535; G06Q 50/00

(52) U.S. Cl. CPC G06F 16/9536; G06F 16/9535; G06Q 50/01

(57) ABSTRACT

A method for recommending a social user, an electronic device and a non-transitory computer-readable storage medium are provided. The method includes the following operations: receiving a message indicating that a first social user access a social user recommendation interface in a specified application, and acquiring a social relationship network of the first social user from an established social relationship database according to the identification of the first social user carried in the message, determining intimacy degree between each second social user and the first social user that is in an indirect social relationship with the first social user in the specified application according to the social relationship network, so as to recommend to the first social user according to the intimacy degree.

### CROSS-REFERENCE TO RELATED APPLICATIONS

The present application is a continuation application of PCT Application No.PCT/CN2021/075580, entitled “METHOD FOR MAKING SOCIAL NETWORKING ACCOUNT RECOMMENDATION AND ELECTRONIC DEVICE” filed on Feb. 5, 2021, which is based upon and claims priority to Chinese Patent Application No. 202010080668.7, filed Feb. 5, 2020, the entire content of which is incorporated herein by reference.

### TECHNICAL FIELD

The present disclosure relates to a field of internet technology, and more particularly to a method for recommending a social user, an electronic device and a non-transitory computer-readable storage medium.

### BACKGROUND

In the related art, one or more other social users are recommended to a current social user based on one-dimensional information acquired by an application.

Taking the recommendation of other social user (hereinafter referred to as user Q) to a social user P (hereinafter referred to as user P) in application 1 as an example, one solution is to match an acquired contact list of the user P with all users in application 1, find the user Q that also uses the application 1 in the contact list of the user P, and then recommend the user to the user P. However, the user Q in the contact list is not necessarily close to the user P, and a probability that the user P interacts with user Q who is not close is not high, leading to a low accuracy rate of recommendation.

Another solution is to determine users Q, from all users of application 1, whose geographical locations are within a set range with a geographical location of the user P, and then recommend these users Q to the user P. In fact, for the user P, many users within the same geographical location are strangers, and a probability of interaction between the user P and strangers is not high, either, also leading to a low accuracy rate of recommendation.

### SUMMARY

The present disclosure provides a method for recommending a social user, an electronic device and a non-transitory computer-readable storage medium, to at least solve problem of the low accuracy rate of recommending a social user to a certain social user in the related art. Technical solutions of the present disclosure are as follows:

According to a first aspect of embodiments of the present disclosure, a method for recommending a social user is provided and includes: receiving a message indicating that a first social user accesses a user interface in a first application, wherein the message carries an identification of the first social user; acquiring, according to the identification, social relationship data of the first social user, wherein the social relationship data indicates a direct relationship and an indirect relationship of the first social user; determining, according to the social relationship data, intimacy degree between a second social user and the first social user, wherein the second social user and the first social user are in the indirect relationship in the first application, and the intimacy degree indicates a probability of establishing the direct relationship between the first social user and the second social user in the first application; determining, according to the intimacy degree, whether to recommend the second social user to the first social user on the user interface.

According to a second aspect of embodiments of the present disclosure, an electronic device is provided and includes: a processor; and a memory configured for storing an executable instruction of the processor; the processor is configured to execute the instruction to implement a method for recommending a social user, and the processor is configured for: receiving a message indicating that a first social user accesses a user interface in a first application, wherein the message carries an identification of the first social user; acquiring, according to the identification, social relationship data of the first social user, wherein the social relationship data indicates a direct relationship and an indirect relationship of the first social user; determining, according to the social relationship data, intimacy degree between a second social user and the first social user, wherein the second social user and the first social user are in the indirect relationship in the first application, and the intimacy degree indicates a probability of establishing the direct relationship between the first social user and the second social user in the first application; determining, according to the intimacy degree, whether to recommend the second social user to the first social user on the user interface.

According to a third aspect of embodiments of the present disclosure, a non-transitory computer-readable storage medium is provided, an instruction in the storage medium, when executed by a processor of an electronic device, enables the electronic device to execute a method for recommending a social user, the method includes: receiving a message indicating that a first social user accesses a user interface in a first application, wherein the message carries an identification of the first social user; acquiring, according to the identification, social relationship data of the first social user, wherein the social relationship data indicates a direct relationship and an indirect relationship of the first social user; determining, according to the social relationship data, intimacy degree between a second social user and the first social user, wherein the second social user and the first social user are in the indirect relationship in the first application, and the intimacy degree indicates a probability of establishing the direct relationship between the first social user and the second social user in the first application; determining, according to the intimacy degree, whether to recommend the second social user to the first social user on the user interface.

### BRIEF DESCRIPTION OF THE DRAWINGS

FIG. 1 is a schematic view of a social relationship network of a social user a according to an embodiment.

FIG. 2 is a schematic view of a social relationship network of another social user a according to an embodiment.

FIG. 3 is an application scenario view of a method for recommending a social user illustrated according to an embodiment.

FIG. 4 is a flowchart of a method for recommending a social user illustrated according to an embodiment.

FIG. 5 is a flowchart of a method for determining intimacy degree between a second social user and a first social user according to an embodiment.

FIG. 6 is a flowchart of a method for determining a first social relationship value between a second social user and a first social user according to an embodiment.

FIG. 7 is a flowchart of another method for determining an intimacy degree between the second social user and the first social user according to an embodiment.

FIG. 8 is a schematic view of a social relationship network of a social user b according to an embodiment.

FIG. 9 is a block diagram of an apparatus for recommending a social user illustrated according to an embodiment.

FIG. 10 is a structural view of an electronic device for implementing a method for recommending a social user according to an embodiment.

### DETAILED DESCRIPTION

In order to make a person skilled in the art better understand the technical solutions of the present disclosure, the technical solutions in embodiments of the present disclosure will be clearly and completely described below with reference to the accompanying drawings.

It should be noted that in the present specification, the claims, and the accompanying drawings of the present disclosure, the terms “first”, “second”, and the like are intended to distinguish between similar objects but do not necessarily indicate a specific order or sequence. It is to be understood that data termed in such way is interchangeable in proper circumstances, so that the embodiments of the present disclosure described herein may be implemented in other sequences than the sequence illustrated or described herein. The implementations set forth in the following description of the embodiments do not represent all implementations consistent with the present disclosure. Rather, they are merely examples of devices and methods consistent with some aspects of the present disclosure as recited in the appended claims.

The relevant information of user accounts (including social relationship identity information and the like) described in the embodiments of the disclosure is obtained under user permission. On the premise of obtaining user permission and authorization, the method, apparatus, device and storage medium involved in the disclosure can obtain the relevant information of users.

In order to facilitate the understanding of this disclosure, technical terms involved in this disclosure include:

a social relationship network of a social user a is used to store social relationship data which indicates direct social relationship and indirect social relationship of the social user a in different applications. If the social user q and the social user a are in the direct social relationship in an application, this direct social relationship in the application may be expressed as: the social user q being in contacts of the social user a, the social user q being in a contact list of the social user a, the social user q and the social user a being mutual followers, and the like. In the application, a social user that is not in a direct social relationship with the social user a is a social user that is in an indirect social relationship with the social user a. Assuming that a social user n and the social user a are in the indirect social relationship in this application, this indirect social relationship in the application may be expressed as: both a social user q and a social user a being in contacts of a social user, both the social user q and the social user a being in a contact list of a social user, both the social user q and the social user a following a social user, and the like.

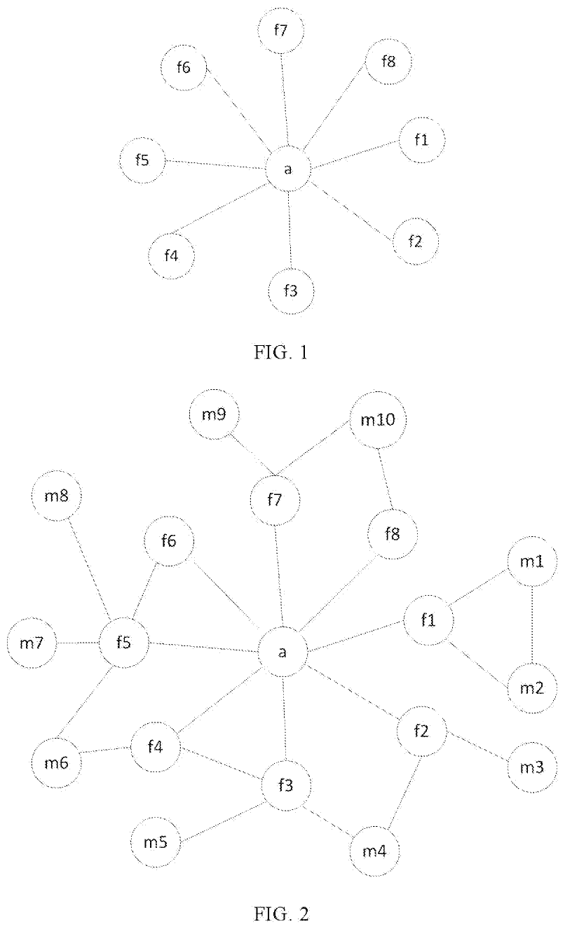

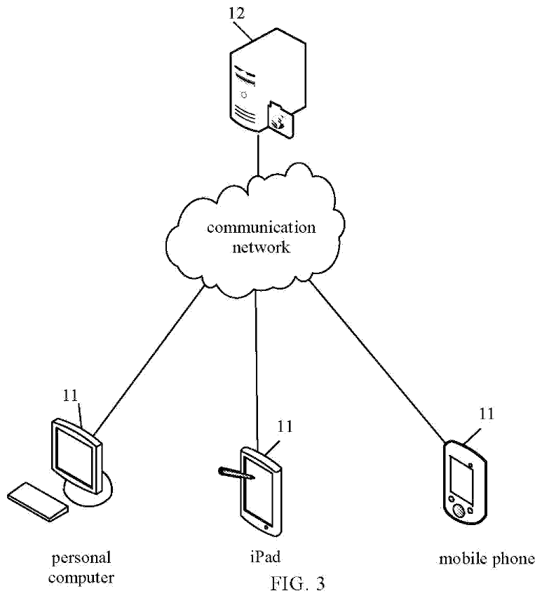

FIG. 1 is a schematic view of a social relationship network of a social user a according to an embodiment. Social users f1-f8 are social users that are in a direct social relationship with a social user a in different applications. Similarly, each social user fi (1≤i≤8) in FIG. 1 also has its own social relationship network. Connecting the social relationship network of the social user a with the social relationship network of social user fi may acquire a larger social relationship network of social user A. FIG. 2 is a schematic view of a social relationship network of another social user a according to an embodiment. Social users m1-m10 are social users that are in an indirect social relationship with the social user a in different applications.

In addition, social users that are in the direct social relationship with the social user a may also be in the direct social relationship, such as social users f5 and f6 in FIG. 2. In practical, the social relationship network of the social user a in FIG. 2 may be further expanded to acquire a larger social relationship network of the social user a, which will not be repeated here.

A social link refers to social relationship data from a social user to another social user in the social relationship network. As illustrated in FIG. 2, a->f1->m1, a->f1->m2 are all social links, and length of the social link is equal to a total number of social users on the social link minus one.

FIG. 3 is an application scenario view of a method for recommending a social user illustrated according to an embodiment, and includes a terminal 11 and a server 12 connected with the terminal 11 through a communication network, in which:

the terminal 11, such as personal computer, iPad, mobile phone, and the like. In a specific implementation, when the terminal 11 detects an operation that the social user recommendation interface is accessed in a specified application, such as a first application, the terminal may send a message to the server 12 indicating that a first social user accesses the social user recommendation interface in the specified application.

When receiving the message sent by the terminal, the server 12 may acquire a social relationship network of the first social user from an established social relationship database according to the identification, and a social relationship data, indicating a direct social relationship and an indirect social relationship of the first social user in different applications, is stored in the social relationship network. Then, according to the acquired social relationship network, the server determines intimacy degree between each second social user and the first social user, the second social user and the first social user are in the indirect social relationship in the specified application, and the intimacy degree indicates a probability of establishing the direct social relationship between the first social user and the second social user in the specified application. After that, the server recommends the social user to the first social user on the social user recommendation interface, according to the intimacy degree between the each second social user and the first social user.

In some embodiments, the social relationship network of the first social user stores the social relationship data that indicates the direct social relationship and the indirect social relationship of the first social user in different applications. In this way, the social relationship network of the first social user is relatively dense, and in the relatively dense social relationship network, the intimacy degree between the each second social user that is in the indirect social relationship with the first social user in the specified application and the first social user is determined, and according to the determined intimacy degree, the social user is recommended to the first social user. Thus, not only may more social users close to the first social user be found, but also an accuracy rate of the social user recommendation is relatively high.

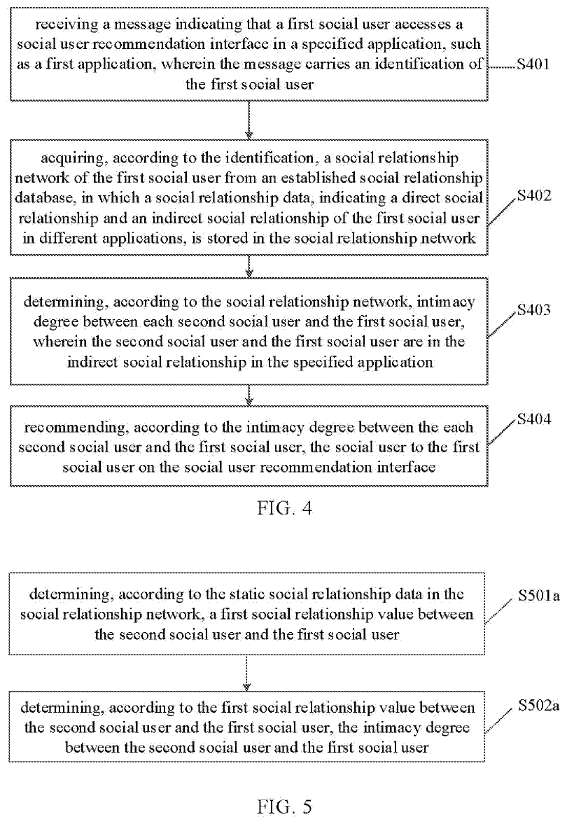

FIG. 4 is a flowchart of a method for recommending a social user illustrated according to an embodiment. As illustrated in FIG. 4, the method for recommending a social user is performed in a server 12, and the flowchart of the method includes S401, S402, S403 and S404.

S401: receiving a message indicating that a first social user accesses a social user recommendation interface in a specified application, such as a first application, wherein the message carries an identification of the first social user.

S402: acquiring, according to the identification, a social relationship network of the first social user from an established social relationship database, in which a social relationship data, indicating a direct social relationship and an indirect social relationship of the first social user in different applications, is stored in the social relationship network.

During implementation, the social relationship network of the first social user takes the first social user as a center, and upper limit of length of the social link from the first social user to another social user in the social relationship network is preset by a technician.

In practical, when the first social user authorizes the specified application to access the contact list, the specified application may acquire the social relationship data of the first social user in the contact list, such as contact list information of the first social user in the contact list.

In addition, when the first social user shares a short-video clip or an article stored in the specified application to another application if a user, who is in the direction relationship with the first social user in the another application clicks the short-video clip or the article, the specified application may acquire an identification of the user in the another application, and that is, the specified application acquires the social relationship data of the first social user in the another application.

Moreover, if the user logs in to the specified application by means of authorized login, the specified application may acquire a corresponding relationship between an identification of the user in the specified application and an identification of the user in the another application, and by using the corresponding relationship, the social user that is in the direct social relationship with the first social user in both the specific application and the another application may be determined.

That is, when two applications performs the authorized login to access through the first social user, the application that is accessed with authorization may acquire the social relationship data of the first social user in the authorized application, and collect the social relationship data to acquire the social relationship network of the first social user.

S403: determining, according to the social relationship network, intimacy degree between each second social user and the first social user, wherein the second social user and the first social user are in the indirect social relationship in the specified application.

The intimacy degree indicates a probability of establishing the direct social relationship between the first social user and the second social user in the specified application.

FIG. 5 is a flowchart of a method for determining intimacy degree between a second social user and a first social user according to an embodiment. In some embodiments, the social relationship data stored in the social relationship network of the first social user only includes static social relationship data. The intimacy degree between the second social user and the first social user may be determined according to a process illustrated in FIG. 5. The process includes S501a and S502a:

S501a: determining, according to the static social relationship data in the social relationship network, a first social relationship value between the second social user and the first social user;

in which the first social relationship value indicates a probability of establishing the direct social relationship between the first social user and the second social user in the specified application based on the static social relationship data.

FIG. 6 is a flowchart of a method for determining a first social relationship value between a second social user and a first social user according to an embodiment. In some embodiments, the first social relationship value between the second social user and the first social user may be determined according to a process illustrated in FIG. 6. The process includes S601a and S602a:

S601a: selecting at least one social link from the first social user to the second social user based on the social relationship network.

Considering that in real life, the first social user generally does not get to know the second social user through too many people, during a specific implementation, length of the social link from the first social user to the second social user may also be limited.

S602a: determining, according to static social relationship data of adjacent social users on each social link in different applications, the first social relationship value between the second social user and the first social user.

The adjacent social users refer to two social users with the direct social relationship on each social link.

During a specific implementation, for each pair of adjacent social users on each social link, according to the static social relationship data of the pair of the adjacent social users in each application, such as a second application, and a preset conversion relationship between the static social relationship data and the social relationship value in the application, social relationship value of the pair of the adjacent social users in the application may be determined. The social relationship value of the pair of the adjacent social users in the application indicates contribution of the application to the social relationship value between the pair of the adjacent social users.

In some embodiments, the static social relationship data of the pair of the adjacent social users in the application is converted into the social relationship value s of the pair of the adjacent social users in the application according to a following formula:

$$s = \frac{{n}_{12}}{{n}_{1} {n}_{2}} ;$$

n₁₂ is a number of social users that are in the direct social relationship with a target social user in a specified application and an application, n₁ is a number of social users that are in the direct social relationship with the target social user in the specified application, and n₂ is a number of social users that are in the direct social relationship with the target social user in the application. Here, the target social user may be any one of two social users contained in the pair of the adjacent social users.

In some embodiments, the static social relationship data of the pair of the adjacent social users in the application is converted into the social relationship value s of the pair of the adjacent social users in the application according to a following formula:

$$s = \frac{{n}_{12}}{{n}_{2}} ;$$

n₁₂ is a number of social users that are in the direct social relationship with a target social user in a specified application and an application, and n₂ is a number of social users that are in the direct social relationship with the target social user in the application. Here, the target social user may be any one of two social users contained in the pair of the adjacent social users.

Then, the social relationship value between the pair of the adjacent social users is determined according to the social relationship value of the pair of the adjacent social users in each application, and the social relationship value between the pair of the adjacent social users indicates contribution of the pair of the adjacent social users to the social relationship value of the social link.

In some embodiments, sum of the social relationship value of the pair of the adjacent social users in each application is determined as the social relationship value between the pair of the adjacent social users.

Further, the social relationship value of the social link is determined according to the social relationship value between each pair of the adjacent social users on the social link. The social relationship value of the social link indicates a probability of establishing the direct social relationship between the first social user and the second social user in the specified application through the social link.

In some embodiments, the social relationship value between each pair of the adjacent social users on the social link is multiplied, and the product is taken as the social relationship value of the social link.

Finally, the first social relationship value between the second social user and the first social user is determined according to the social relationship value of each social link.

In some embodiments, the sum of the social relationship value of each social link is determined as the first social relationship value between the second social user and the first social user.

S502a: determining, according to the first social relationship value between the second social user and the first social user, the intimacy degree between the second social user and the first social user.

In a specific implementation, the first social relationship value between the second social user and the first social user may be directly determined as the intimacy degree between the second social user and the first social user, or the product of the first social relationship value between the second social user and the first social user with a preset weight may be determined as the intimacy degree between the second social user and the first social user.

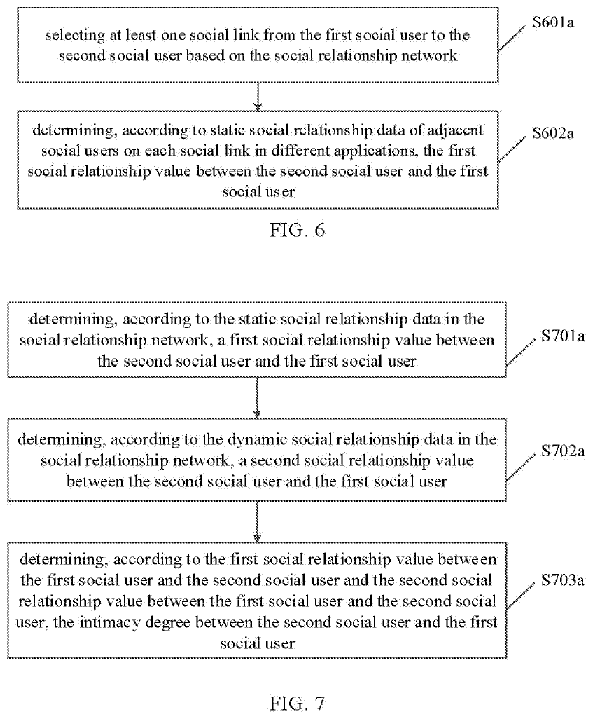

FIG. 7 is a flowchart of another method for determining an intimacy degree between the second social user and the first social user according to an embodiment. In some embodiments, the social relationship data stored in the social relationship network of the first social user may include dynamic social relationship data in addition to the static social relationship data. The intimacy degree between the second social user and the first social user may be determined according to a process illustrated in FIG. 7. The process includes the S701a, S702a and S703a:

S701a: determining, according to the static social relationship data in the social relationship network, a first social relationship value between the second social user and the first social user.

Implementation of S701a is referred to the implementation of S501a, which will not be repeated here.

S702a: determining, according to the dynamic social relationship data in the social relationship network, a second social relationship value between the second social user and the first social user.

The second social relationship value indicates a probability of establishing the direct social relationship between the first social user and the second social user in the specified application based on the dynamic social relationship data.

During a specific implementation, two solutions are provided. A first solution is as follows: the second social relationship value between the second social user and the first social user may be determined according to the dynamic social relationship data of the second social user and the first social user in different applications. A second solution is as follows: the second social relationship value between the second social user and the first social user may be determined only according to the dynamic social relationship data of the second social user and the first social user in the specified application. The dynamic social relationship data considered in the first solution is much richer, and collection for the dynamic social relationship data in the second solution is relatively simple, which may be determined by a technician according to an actual situation.

For the second solution, the method of determining the second social relationship value between the second social user and the first social user according to the dynamic social relationship data in the social relationship network is introduced below.

In some embodiments, a scoring rule of the second social relationship value is that the second social user and the first social user interact once in the specified application, and the second social relationship value is increased by 1, and initial value of the second social relationship value is preset as 0.

In some embodiments, a scoring rule of the second social relationship value is that the first social user actively interacts with the second social user once, the second social relationship value is increased by one, the first social user passively interacts with the second social user once, and the second social relationship value is increased by 0.5. The first social user actively interacts with the second social user, such as the first social user actively sending a message to the second social user, and the first social user passively interacts with the second social user, such as the first social user giving a thumps-up to work uploaded by the second social user.

S703a: determining, according to the first social relationship value between the first social user and the second social user and the second social relationship value between the first social user and the second social user, the intimacy degree between the second social user and the first social user.

In some embodiments, the intimacy degree Q between the second social user and the first social user is determined according to a following formula:

[symbol]

=α*S1+β*S2

S1 is a first social relationship value between the second social user and the first social user, S2 is a second social relationship value between the second social user and the first social user, α, β are preset weights, such as α=0.9, β=0.1.

S404: recommending, according to the intimacy degree between the each second social user and the first social user, the social user to the first social user on the social user recommendation interface.

During a specific implementation, each second social user may be sorted according to the intimacy degree, and first N social users with the highest intimacy degree may be selected to form a recommendation list, and then each social user in the recommendation list may be recommended to the first social user, N is an integer greater than zero.

In addition, the first social user may have rejected some social users before. Thus, if these social users are included in the recommendation list, these social users may also be filtered from the recommendation list, then the recommendation list may be supplemented with other social users according to order of the intimacy degree, and after that, each social user in the recommendation list may be recommended to the first social user. In this way, the social user, whom the first social user refuses to establish the direct social relationship with, may be avoided from being repeatedly recommended to the first social user, so as to further improve a success rate of recommendation of the social user and improve user experience.

The method or electronic device provided by the embodiments of the present disclosure may receive a message indicating that a first social user access a social user recommendation interface in a specified application, and acquire a social relationship network of the first social user from an established social relationship database according to the identification of the first social user carried in the message, determine intimacy degree between each second social user and the first social user that is in an indirect social relationship with the first social user in the specified application according to the social relationship network, so as to recommend to the first social user according to the intimacy degree. The method and device provided by the embodiments of the present disclosure may find social users with high intimacy degree with the first social user, and also improve an accuracy rate of the social user recommendation.

The technical solution of the present disclosure is introduced below in combination with specific embodiments.

Assuming that a server receives a message indicating a social user b accesses a social user recommendation interface in application 1, according to an identification of the social user b carried in the message, a social relationship network of the social user b from an established social relationship database, a social relationship network of the social user b may be acquired, and the social relationship network of the social user b stores social relationship data indicating a direct social relationship and an indirect social relationship of the social user b in different applications.

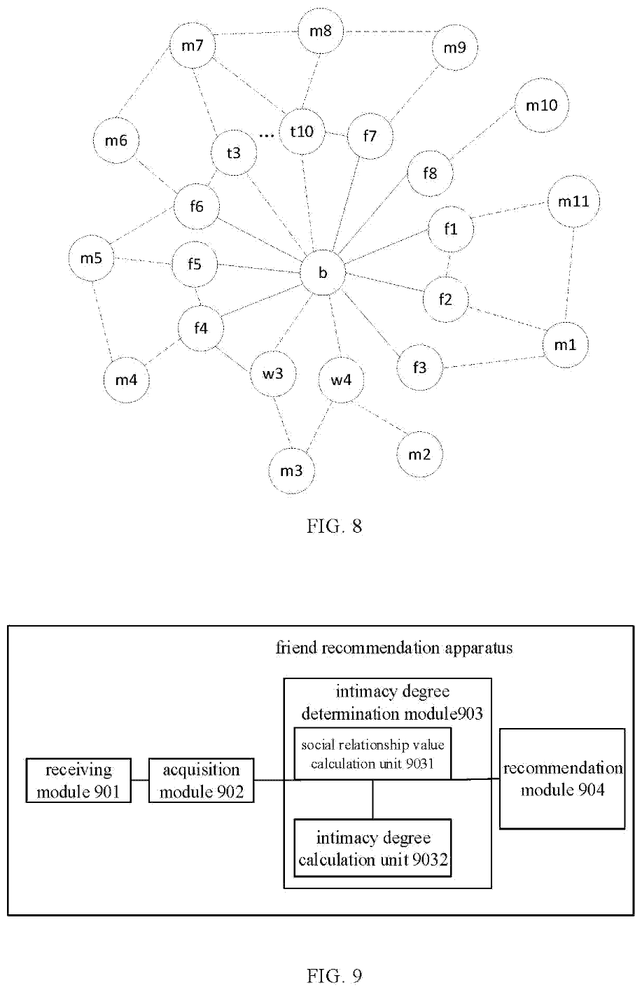

FIG. 8 is a schematic view of a social relationship network of a social user b according to an embodiment. There are 8 social users that are in the direct social relationship with the social user b in the application 1: social user f1-social user f8. In application 2, there are 10 social users that are in the direct social relationship with the social user b: social user f1, social user f2, social user t3-social user t10. In application 3, there are four social users that are in the direct social relationship with the social user b: social user f2, social user f3, social user w3, social user w4. Social users m1-m11 have the indirect social relationship with the social user b.

For clarity, in FIG. 8, the social users that are in the direct social relationship with social user b in the application 1 are marked with a solid line, and the social users that have the indirect social relationship with the social user b in the application 1 are marked with a dotted line.

Further, in the social relationship network of the social user b, for each social user that has the indirect social relationship with the social user b in the application 1, an intimacy degree between the social user and the social user b is determined.

For the social user m1 in FIG. 8, a process of determining the intimacy degree between social user m1 and social user b is described below.

First, a social link from the social user b to the social user m1 in the social relationship network may be determined:

social link 1: b->f2->m1, which means that in the application 1, the social user b may know the social user m1 through the social user f2;

social link 2: b->f3->m1, which means that in the application 1, the social user b may know the social user m1 through social user f3;

social link 3: b->f1->f2->m1, which means that in the application 1, the social user b may know the social user m1 through social users f1 and f2;

social link 4: b->f1->m11->m1 means that in the application 1, the social user b may know the social user m1 through the social users f1 and m11;

Assuming that only social user whose length of the social link does not exceed 2 is recommended, only the social link 1 and the social link 2 remain in the above social link.

Taking the social link 1 as an example, the following describes a process of calculating the social relationship value of the social link 1.

The social link 1 includes two pairs of adjacent social users (b, f2) and (f2, m1) with the direct social relationship. The social user b and the social user f2 are friends in application 1, application 2 and application 3, and the social user f2 and the social user m1 are friends in application 1.

During a specific implementation, for the application 1, a social relationship value of adjacent social users after friend relationship data in application 1 is converted may be set to a specified value, such as 0.5. For another application except application 1, the friend relationship data of a target social user in the application may be converted into the social relationship value s of the adjacent social users in the application according to a following formula:

$$s = \frac{{n}_{12}}{{n}_{1} {n}_{2}} ;$$

n₁₂ is a number of the social user that is in the direct social relationship with the target social user in application 1 and the application, n₁ is a number of the social user that is in the direct social relationship with the target social user in application 1, and n₂ is a number of the social user that is in the direct social relationship with the target social user in the application, the target social user may be any one of two social users contained in the pair of the adjacent social users.

For each pair of adjacent social users in (b, f2) and (f2, m1), after determining the social relationship value of the pair of the adjacent social users in each application, sum of the social relationship value of the pair of the adjacent social users in each application may be determined as the social relationship value between the pair of the adjacent social users, and the product of the social relationship values of (b, f2) and (f2, m1) is determined as the social relationship value of the social link 1.

In the same way, the social relationship value of the social link 2 may be calculated, and thus, a first social relationship value between the social user m1 and the social user b may be sum of the social relationship values of the social link 1 and the social link 2.

Assuming that the social relationship data stored in the social relationship network of social user b also includes dynamic social relationship data, the second social relationship value between the social user m1 and the social user b may also be determined according to the dynamic social relationship data of the social user m1 and the social user b in the application 1.

Further, the intimacy degree Q between the social user m1 and the social user b is determined according to a following formula:

[symbol]

=α*S1+β*S2;

S1 is the first social relationship value between the social user m1 and the social user b, S2 is the second social relationship value the social user m1 and the social user b, α, β are preset weights.

Then, the determined intimacy degree may be sorted, and first 10 social users with the highest intimacy degree may be recommended to the social user b.

When the method provided in the embodiments of the present disclosure is implemented in software or hardware or a c combination thereof, an electronic device may include a plurality of functional modules, and each functional module may include software, hardware or a combination thereof.

In some embodiments, FIG. 9 is a block diagram of an apparatus for recommending a social user illustrated according to an embodiment, the apparatus includes a receiving module 901, an acquisition module 902, an intimacy degree determination module 903, and a recommendation module 904.

The receiving module 901 is configured to execute receiving a message indicating that a first social user accesses a social user recommendation interface in a specified application, such as a first application, wherein the message carries an identification of the first social user;

the acquisition module 902 is configured to execute acquiring, according to the identification, a social relationship network of the first social user from an established social relationship database, wherein a social relationship data, indicating a direct social relationship and an indirect social relationship of the first social user in different applications, is stored in the social relationship network;

the intimacy degree determination module 903 is configured to execute determining, according to the social relationship network, intimacy degree between each second social user and the first social user, wherein the second social user and the first social user are in the indirect social relationship in the specified application, and the intimacy degree indicates a probability of establishing the direct social relationship between the first social user and the second social user in the specified application;

the recommendation module 904 is configured to execute recommending, according to the intimacy degree as determined between the each second social user and the first social user, the social user to the first social user on the social user recommendation interface.

In some embodiments, the social relationship data at least includes static social relationship data, and the intimacy degree determination module 903 specifically includes:

a social relationship value calculation unit 9031 configured to execute determining, according to the static social relationship data in the social relationship network, a first social relationship value between the second social user and the first social user, wherein the first social relationship value indicates a probability of establishing the direct social relationship between the first social user and the second social user in the specified application based on the static social relationship data;

an intimacy degree calculation unit 9032 configured to execute determining, according to the first social relationship value, the intimacy degree between the second social user and the first social user.

In some embodiments, the social relationship value calculation unit 9031 is specifically configured to execute

selecting at least one social link from the first social user to the second social user based on the social relationship network;

determining, according to static social relationship data of adjacent social users on each social link in different applications, the first social relationship value between the second social user and the first social user, wherein the adjacent social users refer to two social users with the direct social relationship on each social link.

In some embodiments, the social relationship value calculation unit 9031 is specifically configured to execute

determining, according to the static social relationship data of each adjacent social users on each social link in different applications, a social relationship value of the social link, wherein the social relationship value of the social link indicates a probability of establishing the direct social relationship between the first social user and the second social user in the specified application through the social link;

determining, according to the social relationship value of each social link, the first social relationship value between the second social user and the first social user.

In some embodiments, the social relationship value calculation unit 9031 is specifically configured to execute

for each pair of the adjacent social users on the social link, determining, according to the static social relationship data of the adjacent social users in different applications, a social relationship value between the adjacent social users, wherein the social relationship value between the adjacent social users indicates contribution of the adjacent social users to the social relationship value of the social link;

determining the social relationship value of the social link according to the social relationship value between the adjacent social users.

In some embodiments, the social relationship value calculation unit 9031 is specifically configured to execute

determining, according to the static social relationship data of the adjacent social users in each application, such as a second application, and a preset conversion relationship between the static social relationship data and the social relationship value in the application, a social relationship value of the adjacent social users in the application, wherein the social relationship value of the adjacent social users in the application indicates contribution of the application to the social relationship value between the adjacent social users;

determining, according to the social relationship value of the adjacent social users in each application, the social relationship value between the adjacent social users.

In some embodiments, if the social relationship data further includes dynamic social relationship data, the social relationship value calculation unit 9031 is further configured to execute

determining, according to the dynamic social relationship data in the social relationship network, a second social relationship value between the second social user and the first social user, and the second social relationship value indicates a probability of establishing the direct social relationship between the first social user and the second social user in the specified application based on the dynamic social relationship data;

the intimacy degree calculation unit 9032 is configured to execute determining, according to the first social relationship value and the second social relationship value, the intimacy degree between the second social user and the first social user.

As for the apparatus in the above embodiments, the specific mode of operation of each module has been described in detail in the embodiments of the method, which will not be described in detail here.

The division of modules in the embodiments of the present disclosure is schematic, which is only a logical function division, can be divided in another way when actually implemented. In addition, the functional modules in the embodiments of the present disclosure may be integrated in one processor, may physically exist in separate, or may be two or more than two modules integrated in one module. The coupling between each module may be achieved through some interfaces, which are usually electrical communication interfaces, or mechanical interfaces or other forms of interfaces. Therefore, the modules described as separate parts may be or may not be physically separated, and may be located in one place or distributed to different positions of the same or different device. The above integrated modules may be implemented in the form of hardware or software function modules.

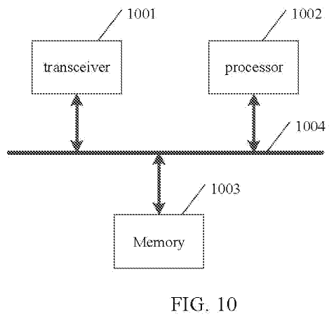

FIG. 10 is a structural view of an electronic device for implementing a method for recommending a social user according to an embodiment. The electronic device includes physical components such as a transceiver 1001 and a processor 1002. The processor 1002 may be a central processing unit (CPU), a microprocessor, an application-specific integrated circuit, a programmable logic circuit, a large-scale integrated circuit, or a digital processing unit, and the like. The transceiver 1001 is used for data transmission and reception by electronic devices and other devices.

The electronic device may further include a memory 1003 for storing a software instruction executed by the processor 1002. Of course, the memory may also store some other data required by the electronic device, such as identification information of the electronic device, encryption information of the electronic device, user data, and the like. The memory 1003 may be volatile memory, such as random access memory (RAM); The memory 1003 may also be non-volatile memory, such as read-only memory (ROM), flash memory, hard disk drive (HDD) or solid state drive (SSD), or, the memory 1003 is any other medium that may be used to carry or store desired program code in form of instructions or data structures and is accessible by a computer, but is not limited to this. The memory 1003 may be a combination of the above memories.

In the embodiment of the present disclosure, a specific connection medium among the processor 1002, the memory 1003 and the transceiver 1001 is not limited. FIG. 10 of the embodiment of the present disclosure only takes the memory 1003, the processor 1002 and the transceiver 1001 being connected through a bus 1004 as an example, in which the bus is represented by a thick line in FIG. 10, and connection modes between other components are only schematically illustrated, and cannot be construed as a limitation. The bus may include an address bus, a data bus, a control bus, and the like. For ease of representation, only one thick line is used in FIG. 10, but it does not mean that there is only one bus or one type of bus.

The processor 1002 may be a dedicated hardware processor or a running software processor. When the processor 1002 may run software, the processor 1002 reads the software instruction stored in the memory 1003, and executes the method for recommending a social user involved in the foregoing embodiments driven by the software instruction.

The embodiments of the present disclosure also provide a storage medium. When the instructions in the storage medium are executed by the processor of the electronic device, the electronic device may execute the method for recommending a social user involved in the foregoing embodiments.

In some embodiments, various aspects of the method for recommending a social user provided by the present disclosure may also be implemented in form of a program product, which includes program code. When the program product runs on an electronic device, the program code is used for the electronic device executing the method for recommending a social user involved in the foregoing embodiments.

The program product may employ any combination of one or more readable mediums. The readable medium may be a readable signal medium or a readable storage medium. The readable storage medium may be, for example, but is not limited to, an electronic, magnetic, optical, electromagnetic, infrared, or semiconductor system, apparatus, or device, or any combination thereof. More specific examples (non-exhaustive examples) of readable storage media include: electrical connection with one or more wires, portable disk, hard disk, random access memory (RAM), read-only memory (ROM), erasable programmable read-only memory (EPROM or flash memory), optical fiber, portable compact disc read-only memory (CD-ROM), optical storage device, magnetic storage device, or any suitable combination of the foregoing.

The program product for recommending a social user provided by the embodiments of the present disclosure may adopt portable compact disk read-only memory (CD-ROM) and include program code, and may run on a computing device. However, the program product of the present disclosure is not limited to this. In this document, the readable storage medium may be any tangible medium containing or storing a program, which may be used by or in combination with an instruction execution system, apparatus, or device.

The readable signal medium may include a data signal in baseband or propagated as part of a carrier wave, which carries readable program codes. Such a propagated data signal may have many forms, including but not limited to electromagnetic signals, optical signals, or any suitable combination of the foregoing. The readable signal medium may also be any readable medium other than a readable storage medium, and the readable medium may send, propagate, or transmit a program that is used by an instruction execution system, apparatus, or device, or that is used in combination with an instruction execution system, apparatus, or device.

The program codes contained on the readable medium may be transmitted using any appropriate medium, including but not limited to wireless, wired, optical fiber, RF, etc., or any suitable combination of the foregoing.

The program codes for performing the operations of the present disclosure may be written in any combination of one or more programming languages, which include object-oriented programming languages, such as Java, C++, and so on. The programming languages also include conventional procedural programming language, such as “C” or a similar programming language. The program codes may be executed entirely on the user computing device, may be executed partly on the user device, may be executed as an independent software package, may be executed partly on the user computing device and partly on a remote computing device, or may be executed entirely on the remote computing device or server. In the case of a remote computing device, the remote computing device may be connected to the user computing device through any kind of network, including a local area network (LAN) or a wide area network (WAN), or the remote computing device may be connected to an external computing device, for example, by the Internet provided by the Internet service providers.

It should be noted that although several units or subunits of the device are described above, such division is merely exemplary rather than mandatory. In fact, according to the embodiments of the present disclosure, the features and functions of two or more modules or units described above may be embodied in one unit. Conversely, the features and functions of a unit described above may be further divided into multiple units to be embodied.

Furthermore, although various steps of the methods of the present disclosure are described in a particular order in the drawings, this should not be understood as requiring or implying that such operations must be performed in the particular order, or that all illustrated operations must be performed, to achieve desirable results. Additionally or alternatively, certain steps may be omitted, multiple steps may be combined into one step, and/or one step may be split into multiple steps.

Those skilled in the art should understand that embodiments of the present disclosure may be provided as a method, a system, or a computer program product. Thus, the present disclosure may take the form of a full hardware embodiment, a full software embodiment, or an embodiment combining software and hardware. Moreover, the present disclosure may take the form of a computer program product implemented on one or more computer usable storage media (including but not limited to disk memory, CD-ROM, optical memory, and the like) including computer usable program code.

The present disclosure is described with reference to flowcharts and/or block diagrams of methods, devices (systems), and computer program products according to embodiments of the present disclosure. It should be understood that each process and/or block and the combination thereof in the flowchart and/or block diagram may be achieved by a computer program instruction. These computer program instructions may be provided to a processor of general-purpose computer, special-purpose computer, embedded processor or other programmable data processing device to generate a machine, such that the instruction, performed by a processor of a computer or other programmable data processing device, generates an apparatus for achieving functions specified in one or more processes of the flowchart and/or one or more blocks of the block diagram.

These computer program instructions may also be stored in a computer-readable memory that may guide a computer or other programmable data processing device to work in a specific way, so that the instructions stored in the computer-readable memory generate a manufacturing product including an instruction device, and the instruction device implements the functions specified in one or more processes of the flowchart and/or one or more blocks of the block diagram.

These computer program instructions may also be loaded on a computer or other programmable data processing equipment, so that a series of operation steps are performed on the computer or other programmable device to produce computer implemented processing. Thus, instructions performed on a computer or other programmable device provide steps for implementing the functions specified in one or more processes of the flowchart and/or one or more blocks of the block diagram.

Although the preferred embodiments of the present disclosure have been described, those skilled in the art may make additional changes and modifications to these embodiments once they have learned the basic inventive concept. Thus, the appended claims are intended to be interpreted as including preferred embodiments and all changes and modifications that fall within the scope of the present disclosure.

Obviously, those skilled in the art may make various changes and modifications to the disclosure without departing from the spirit and scope of the disclosure. Thus, if these modifications and variations of the present disclosure fall within the scope of the claims of the present disclosure and their equivalents, the present disclosure is also intended to include these modifications and variations.

What is claimed is:

1. A method for recommending a social user, comprising:
receiving a message indicating that a first social user accesses a user interface in a first application, wherein the message carries an identification of the first social user;
acquiring, according to the identification, social relationship data of the first social user, wherein the social relationship data indicates a direct relationship and an indirect relationship of the first social user;
determining, according to the social relationship data, intimacy degree between a second social user and the first social user, wherein the second social user and the first social user are in the indirect relationship in the first application, and the intimacy degree indicates a probability of establishing the direct relationship between the first social user and the second social user in the first application;
determining, according to the intimacy degree, whether to recommend the second social user to the first social user on the user interface.

2. The method according to claim 1, wherein the social relationship data at least comprises static data, and said determining, according to the social relationship data, the intimacy degree between the second social user and the first social user comprises:
determining, according to the static data, a first social relationship value between the second social user and the first social user, wherein the first social relationship value indicates a probability of establishing the direct relationship between the first social user and the second social user in the first application based on the static data;
determining, according to the first social relationship value, the intimacy degree.

3. The method according to claim 2, wherein said determining, according to the static data, the first social relationship value between the second social user and the first social user comprises:
selecting a social link from the first social user to the second social user based on the social relationship data;
determining, according to static data of adjacent social users on the social link, the first social relationship value, wherein the adjacent social users refer to two social users with the direct relationship on the social link.

4. The method according to claim 3, wherein said determining, according to the static data of the adjacent social users on the social link, the first social relationship value comprises:
determining, according to the static data of the adjacent social users on the social link, a social relationship value of the social link, wherein the social relationship value of the social link indicates a probability of establishing the direct relationship between the first social user and the second social user in the first application through the social link;
determining, according to the social relationship value of the social link, the first social relationship value.

5. The method according to claim 4, wherein said determining, according to the static data of the adjacent social users on the social link, the social relationship value of the social link comprises:
for a pair of the adjacent social users on the social link, determining, according to the static data of the adjacent social users, a social relationship value between the adjacent social users, wherein the social relationship value between the adjacent social users indicates contribution of the adjacent social users to the social relationship value of the social link;
determining the social relationship value of the social link according to the social relationship value between the adjacent social users.

6. The method according to claim 5, wherein said determining, according to the static data of the adjacent social users, the social relationship value between the adjacent social users comprises:
determining, according to the static data of the adjacent social users in a second application and a preset conversion relationship between the static data and the social relationship value in the second application, a social relationship value of the adjacent social users in the second application, wherein the social relationship value of the adjacent social users in the second application indicates contribution of the second application to the social relationship value between the adjacent social users;
determining, according to the social relationship value of the adjacent social users in the second application, the social relationship value between the adjacent social users.

7. The method according to claim 2, wherein the social relationship data further comprises dynamic data, the method further comprises:
determining, according to the dynamic data, a second social relationship value between the second social user and the first social user, and the second social relationship value indicates a probability of establishing the direct relationship between the first social user and the second social user in the first application based on the dynamic data; and
determining, according to the first social relationship value and the second social relationship value, the intimacy degree.

8. An electronic device, comprising:
a processor;
a memory configured for storing an executable instruction of the processor;
wherein the processor is configured to execute the instruction to implement a method for recommending a social user,
wherein the processor is configured for:
receiving a message indicating that a first social user accesses a user interface in a first application, wherein the message carries an identification of the first social user;
acquiring, according to the identification, social relationship data of the first social user, wherein the social relationship data indicates a direct relationship and an indirect relationship of the first social user;
determining, according to the social relationship data, intimacy degree between a second social user and the first social user, wherein the second social user and the first social user are in the indirect relationship in the first application, and the intimacy degree indicates a probability of establishing the direct relationship between the first social user and the second social user in the first application;
determining, according to the intimacy degree, whether to recommend the second social user to the first social user on the user interface.

9. The electronic device according to claim 8, wherein the social relationship data at least comprises static data,
wherein the processor is further configured for:
determining, according to the static data, a first social relationship value between the second social user and the first social user, wherein the first social relationship value indicates a probability of establishing the direct relationship between the first social user and the second social user in the first application based on the static data;
determining, according to the first social relationship value, the intimacy degree.

10. The electronic device according to claim 9, wherein the processor is configured for:
selecting a social link from the first social user to the second social user based on the social relationship data;
determining, according to static data of adjacent social users on the social link, the first social relationship value, wherein the adjacent social users refer to two social users with the direct relationship on the social link.

11. The electronic device according to claim 10, wherein the processor is further configured for:
determining, according to the static data of the adjacent social users on the social link, a social relationship value of the social link, wherein the social relationship value of the social link indicates a probability of establishing the direct relationship between the first social user and the second social user in the first application through the social link;
determining, according to the social relationship value of the social link, the first social relationship value.

12. The electronic device according to claim 11, wherein the processor is further configured for:
for a pair of the adjacent social users on the social link, determining, according to the static data of the adjacent social users, a social relationship value between the adjacent social users, wherein the social relationship value between the adjacent social users indicates contribution of the adjacent social users to the social relationship value of the social link;
determining the social relationship value of the social link according to the social relationship value between the adjacent social users.

13. The electronic device according to claim 12, wherein the processor is further configured for:
determining, according to the static data of the adjacent social users in a second application and a preset conversion relationship between the static data and the social relationship value in the second application, a social relationship value of the adjacent social users in the second application, wherein the social relationship value of the adjacent social users in the second application indicates contribution of the second application to the social relationship value between the adjacent social users;
determining, according to the social relationship value of the adjacent social users in the second application, the social relationship value between the adjacent social users.

14. The electronic device according to claim 9, wherein the social relationship data further comprises dynamic data, and the processor is further configured for:
determining, according to the dynamic data, a second social relationship value between the second social user and the first social user, and the second social relationship value indicates a probability of establishing the direct relationship between the first social user and the second social user in the first application based on the dynamic data; and
wherein the processor is further configured for
determining, according to the first social relationship value and the second social relationship value, the intimacy degree.

15. A non-transitory computer-readable storage medium, wherein an instruction in the non-transitory computer-readable storage medium, when executed by a processor of an electronic device, enables the electronic device to execute a method for recommending a social user, wherein the method comprises:
receiving a message indicating that a first social user accesses a user interface in a first application, wherein the message carries an identification of the first social user;
acquiring, according to the identification, social relationship data of the first social user, wherein the social relationship data indicates a direct relationship and an indirect relationship of the first social user;
determining, according to the social relationship data, intimacy degree between a second social user and the first social user, wherein the second social user and the first social user are in the indirect relationship in the first application, and the intimacy degree indicates a probability of establishing the direct relationship between the first social user and the second social user in the first application;
determining, according to the intimacy degree, whether to recommend the second social user to the first social user on the user interface.

16. The non-transitory computer-readable storage medium according to claim 15, wherein the social relationship data at least comprises static data, said determining, according to the social relationship data, the intimacy degree comprises:
determining, according to the static data, a first social relationship value between the second social user and the first social user, wherein the first social relationship value indicates a probability of establishing the direct relationship between the first social user and the second social user in the first application based on the static data;
determining, according to the first social relationship value, the intimacy degree.

17. The non-transitory computer-readable storage medium according to claim 16, wherein said determining, according to the static data, the first social relationship value comprises:
selecting a social link from the first social user to the second social user based on the social relationship data;
determining, according to static data of adjacent social users on the social link, the first social relationship value, wherein the adjacent social users refer to two social users with the direct relationship on the social link.

18. The non-transitory computer-readable storage medium according to claim 17, wherein said determining, according to the static data of the adjacent social users on the social link, the first social relationship value between the second social user and the first social user comprises:
determining, according to the static data of the adjacent social users on the social link, a social relationship value of the social link, wherein the social relationship value of the social link indicates a probability of establishing the direct relationship between the first social user and the second social user in the first application through the social link;
determining, according to the social relationship value of the social link, the first social relationship value.

19. The non-transitory computer-readable storage medium according to claim 18, wherein said determining, according to the static data of the adjacent social users on the social link, the social relationship value of the social link comprises:
for a pair of the adjacent social users on the social link, determining, according to the static data of the adjacent social users, a social relationship value between the adjacent social users, wherein the social relationship value between the adjacent social users indicates contribution of the adjacent social users to the social relationship value of the social link;
determining the social relationship value of the social link according to the social relationship value between the adjacent social users;
wherein said determining, according to the static data of the adjacent social users, the social relationship value between the adjacent social users comprises:
determining, according to the static data of the adjacent social users in a second application and a preset conversion relationship between the static data and the social relationship value in the second application, a social relationship value of the adjacent social users in the second application, wherein the social relationship value of the adjacent social users in the second application indicates contribution of the second application to the social relationship value between the adjacent social users;
determining, according to the social relationship value of the adjacent social users in the second application, the social relationship value between the adjacent social users.

20. The non-transitory computer-readable storage medium according to claim 16, wherein the social relationship data further comprises dynamic data, the method further comprises:
determining, according to the dynamic data, a second social relationship value between the second social user and the first social user, and the second social relationship value indicates a probability of establishing the direct relationship between the first social user and the second social user in the first application based on the dynamic data; and
determining, according to the first social relationship value and the second social relationship value, the intimacy degree.
